(19) United States
(12) Patent Application Publication
(10) Pub. No.: US 2007/0198399 A1
(43) Pub. Date: Aug. 23, 2007

(54) System and method for securing auction payment of monetary, goods, or services

(76) Inventor: Su Van Nguyen, Stockton, CA (US)

Correspondence Address: Su V. Nguyen, 6119 Welch Ave., Stockton, CA, 95210, US

(21) Appl. No.: 11/627,959

(22) Filed: Jan. 27, 2007

Related U.S. Application Data
(60) Provisional application No. 60/762,626, filed on Jan. 27, 2006.

(51) Int. Cl. G06Q 40/00

(52) U.S. Cl. 705/37

(57) ABSTRACT

A system and method that includes web server or a newspaper ad that allows people to auction their monetary, goods or services for someone else monetary, goods, or services by depositing the variable value of the “monetary, goods, or services” in to a Deposit Bank. A System and method comprise of a posting on to the system, the seller a entity monetary, goods, or services willing to exchange for the winning bidder entity monetary, goods, or services in an auction. Monetary is then deposited or hold onto the system owner or third party Deposit Bank. The two entities will deliver monetary, goods, or services as agreed. The monetary is then returned or holds from both entities from the Deposit Bank.

### RELATED APPLICATIONS

The present application is a continuation application of U.S. provisional patent application, Ser. No. 60/762,626, filed Jan. 27, 2006, for SYSTEM AND METHOD PROVIDES FOR SECURING AUCTION PAYMENT OF MONETARY, GOODS, OR SERVICES, by Su Van Nguyen, included by reference herein and for which benefit of the priority date is hereby claimed.

The present application is related to U.S. provisional patent No. 60/748,709, issued Dec. 9, 2005, for SYSTEM AND METHOD PROVIDES FOR TRADING PRODUCTS AND SERVICES, by Su Van Nguyen, included by reference herein.

### FIELD OF THE INVENTION

This invention relates generally to the field of apparatus for a System and method for securing auction payment of monetary, goods, or services. Moreover it pertains specifically to such System and method for securing auction payment of monetary, goods, or services, by means allowing people to receive their monetary, goods, or services once the auction has ended.

### BACKGROUND OF THE INVENTION

People bids or sell stuff through the Internet or through newspaper ads auction. Sometimes, what happens is that winner pays for the product but seller did not deliver the product. It could also happen the other way around. The person therefore gets frustrated. The Internet and newspaper are just examples, it could also be TV or radio. Continuing the entity that decides to purchase more than one item is subject to multiple deposits. This deposit could be added or subtracted from the amount already deposited in the Deposit Bank.

Accordingly several advantages and objects of the present invention are:

A principal object of the present invention is to provide a System and method for securing auction payment of monetary, goods, or services that will overcome the deficiencies of the prior art systems and System and methods.

An object of the present invention is to provide a System and method for securing auction payment of monetary, goods, or services for people to trade in a secure way by depositing variable value.

Another object of the present invention is to provide a System and method for securing auction payment of monetary, goods, or services for people to trade local, national, or international.

Another object of the present invention is to provide a System and method for securing auction payment of monetary, goods, or services for people to get their monetary, goods, or services.

Another object of the present invention is to provide a System and method for securing auction payment of monetary, goods, or services that a Deposit Bank is created which is a place, account, bank, or the like.

Another object of the present invention is to provide a System and method for securing auction payment of monetary, goods, or services that the value of money of the monetary, goods, or services is determined either by the poster or the replier.

Another object of the present invention is to provide a System and method for securing auction payment of monetary, goods, or services that the Deposit Bank releases the monetary value back to the poster and replier.

Another object of the present invention is to provide a System and method for securing auction payment of monetary, goods, or services that allows people to auction their monetary, good or service confidently that it is safe to deliver.

Another object of the present invention is to provide a System and method for securing auction payment of monetary, goods, or services that the Deposit Bank add or subtract the monetary value from the poster and replier.

Another object of the present invention is to provide a System and method for securing auction payment of monetary, goods, or services that allows winner to deposit their monetary, good or service.

Another object of the present invention is to provide a System and method for securing auction payment of monetary, goods, or services that more than one monetary, goods, or services can be posted.

It is intended that any other advantages and objects of the present invention that become apparent or obvious from the detailed description or illustrations contained herein are within the scope of the present invention.

### SUMMARY OF THE INVENTION

In view of the limitations now present in the prior art, the present invention provides a new and useful System and method for securing auction payment of monetary, goods, or services which is simpler in construction, more universally usable and more versatile in operation than known system and System and method of this kind.

The purpose of the present invention is to provide a new System and method for securing auction payment of monetary, goods, or services that has many novel features not offered by the prior art system and System and method that result in a new System and method for securing auction payment of monetary, goods, or services which is not apparent, obvious, or suggested, either directly or indirectly by any of the prior art system and System and method

The present invention generally comprises of a Deposit Bank and System and method of depositing for an auction. The first part is generally an auction by which there are bidders and Seller that bids for monetary, goods, or services. The System and method is therefore a Seller of the goods or services has to deposit a variable monetary value into the Deposit Bank. The First Bidder will bid the goods or services and will also deposit a variable value amount in the Deposit Bank. If a Second Bidder bids at a higher price than the First Bidder then he, she, or entity will deposit a variable value in the Deposit Bank. The money deposited by the First Bidder is return to him, her, or entity. This can occur for more than two bidders. In the end, the trader or bidder that is of the highest bids will deliver monetary, goods or services. The seller will also deposit the variable monetary value to the Deposit Bank. The seller will also delivers his, her, or entity monetary, goods, or services. The monetary deposited is return or kept from to/both the Seller and the bidders. For additional items onto the System additional deposit maybe require. Subtraction of monetary from the Deposit Bank is also allowed.

### BRIEF DESCRIPTION OF THE DRAWINGS

A complete understanding of the present invention may be obtained by reference to the accompanying drawings, when considered in conjunction with the subsequent, detailed description, in which:

FIG. 2 is a front view of an example of the System and method for securing auction payment of monetary, goods, or services according to the present invention.

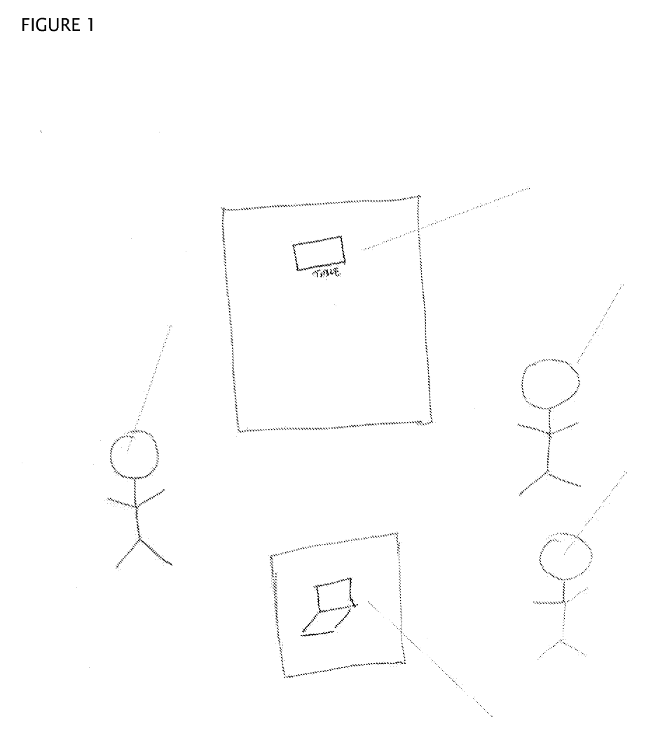

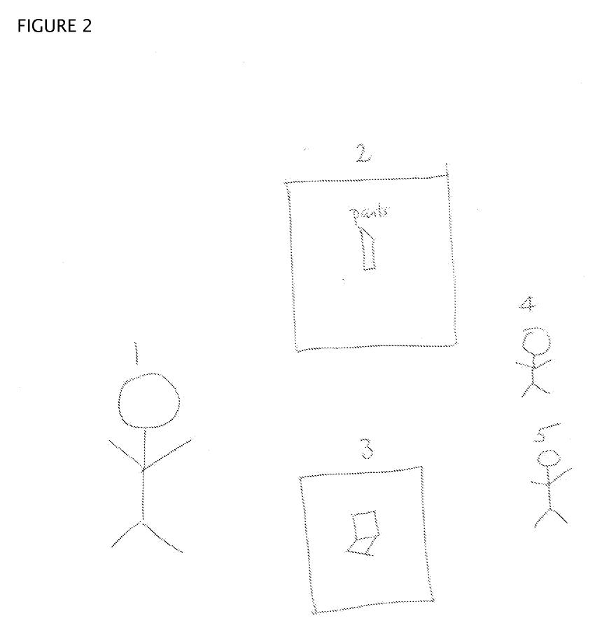

The present example generally comprises of a deposit bank 3 and System and method of depositing for an auction. The first part is generally an auction by which there are bidders (4 and 5) and seller that bids for a pair of pants on the system 2. The System and method is therefore a seller of the pants has to deposit $2.00 into the deposit bank. The first bidder will bid the goods or services and will also deposit a $1.00 amount in the deposit bank. If a second bidder bids at a higher price than the first bidder then he, she, or entity will deposit a $1.50 in the deposit bank. The $1.00 deposited by the first bidder is return to him, her, or entity. In the end, the trader or bidder that is of the highest bids will send the money bided. The sellers will also delivers the pants. The monetary deposited is return or kept from to/both the seller and the bidders. For additional items onto the system additional deposit maybe require. Subtraction of monetary from the deposit bank is also allowed.

For purposes of clarity and brevity, like elements and components will bear the same designations and numbering throughout the Figures.

### DESCRIPTION OF THE PREFERRED EMBODIMENT

FIG. 1 is a front view of a System and method for securing auction payment of monetary, goods, or services according to the present invention.

The present invention generally comprises of a Deposit Bank 14 and System and method of depositing for an auction. The first part is generally an auction by which there are bidders and Seller 18 that bids for monetary, goods, or services. The System and method is therefore a Seller 18 of the goods or services has to deposit a variable monetary value into the Deposit Bank 14. The First Bidder 10 will bid the goods or services and will also deposit a variable value amount in the Deposit Bank 14. If a Second Bidder 12 bids at a higher price than the First Bidder 10 then he, she, or entity will deposit a variable value in the Deposit Bank 14. The money deposited by the First Bidder 10 is return to him, her, or entity. This can occur for more than two bidders. In the end, the trader or bidder that is of the highest bids will deliver monetary, goods or services. The seller 18 will also deposit the variable monetary value to the Deposit Bank 14.The seller 18 will also delivers his, her, or entity monetary, goods, or services. The monetary deposited is return or kept from to/both the Seller 18 and the bidders. For additional items onto the System 16 additional deposit maybe require. Subtraction of monetary from the Deposit Bank 14 is also allowed.

It will also be understood that, in addition, system and method for securing auction payment of monetary, goods, or services, the system can be used for multiple traders that is a Third Trader who wants the monetary, goods, or services from the First Trader. Whereas the First Trader gets to choose a Trader from the list of Traders (Second, Third, Fourth, etc. Trader).

It will also be understood that, in addition, system and method for securing auction payment of monetary, goods, or services, the system can be used on any communication such as radio stations or/and TV programs.

It will also be understood that, in addition system and method for securing auction payment of monetary, goods, or services, the system can be used as a First Trader who wants to auction his or her goods or services plus monetary value for Second Trader goods or services. Or Second Trader wants to pay for goods or services plus monetary value for First Trader goods or services.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A System and method for securing auction payment of monetary, goods, or services, comprising: means for deposit, bids, and delivering “monetary, goods, or services”;
means for deposit, bids, and delivering “monetary, goods or services”;
means for depositing monetary funds into and release the deposited monetary funds, rigidly connected to said means for deposit, bids, and delivering “monetary, goods or services”, and rigidly connected to said means for deposit, bids, and delivering “monetary, goods, or services”;
means for to advertise or post an ad, rigidly connected to said means for deposit, bids, and delivering “monetary, goods or services”, and rigidly connected to said means for deposit, bids, and delivering “monetary, goods, or services”; and
means for post the goods or services for sell, rigidly connected to said means for to advertise or post an ad, and rigidly connected to said means for depositing monetary funds into and release the deposited monetary funds.

2. The System and method in accordance with claim 1, wherein said means for deposit, bids, and delivering “monetary, goods, or services” comprises a person or entity, variable value deposit, deposit value could zero, consent, successive deposit first bidder.

3. The System and method in accordance with claim 1, wherein said means for deposit, bids, and delivering “monetary, goods or services” comprises a person or entity, variable value deposit, deposit value could be zero, successive deposit, higher bidder second bidder.

4. The System and method in accordance with claim 1, wherein said means for depositing monetary funds into and release the deposited monetary funds comprises the owner of the system or third parties, hold or receive funds, return or allow additional funds, could be an account or bank deposit bank.

5. The System and method in accordance with claim 1, wherein said means for to advertise or post an ad comprises a website, newspaper or communication, allows more than one post, could be the owner system.

6. The System and method in accordance with claim 1, wherein said means for post the goods or services for sell comprises a person or entity, variable value deposit, deposit value could be zero, consent, successive deposit seller.

7. A System and method for securing auction payment of monetary, goods, or services, comprising: a person or entity, variable value deposit, deposit value could zero, consent, successive deposit first bidder, for deposit, bids, and delivering “monetary, goods, or services”;
a person or entity, variable value deposit, deposit value could be zero, successive deposit, higher bidder second bidder, for deposit, bids, and delivering “monetary, goods or services”;
the owner of the system or third parties, hold or receive funds, return or allow additional funds, could be an account or bank deposit bank, for depositing monetary funds into and release the deposited monetary funds, rigidly connected to said Second Bidder, and rigidly connected to said First Bidder;
a website, newspaper or communication, allows more than one post, could be the owner system, for to advertise or post an ad, rigidly connected to said Second Bidder, and rigidly connected to said First Bidder; and
a person or entity, variable value deposit, deposit value could be zero, consent, successive deposit seller, for post the goods or services for sell, rigidly connected to said System, and rigidly connected to said Deposit Bank.

8. A System and method for securing auction payment of monetary, goods, or services, comprising: a person or entity, variable value deposit, deposit value could zero, consent, successive deposit first bidder, for deposit, bids, and delivering “monetary, goods, or services”;
a person or entity, variable value deposit, deposit value could be zero, successive deposit, higher bidder second bidder, for deposit, bids, and delivering “monetary, goods or services”;
the owner of the system or third parties, hold or receive funds, return or allow additional funds, could be an account or bank deposit bank, for depositing monetary funds into and release the deposited monetary funds, rigidly connected to said Second Bidder, and rigidly connected to said First Bidder;
a website, newspaper or communication, allows more than one post, could be the owner system, for to advertise or post an ad, rigidly connected to said Second Bidder, and rigidly connected to said First Bidder; and
a person or entity, variable value deposit, deposit value could be zero, consent, successive deposit seller, for post the goods or services for sell, rigidly connected to said System, and rigidly connected to said Deposit Bank.
